(19) United States
(12) Patent Application Publication
(10) Pub. No.: US 2014/0228119 A1
(43) Pub. Date: Aug. 14, 2014

(54) SYSTEM AND METHOD FOR DIRECTED ADVERTISING IN AN ELECTRONIC DEVICE OPERATING SPONSOR-CONFIGURED GAME TEMPLATE

(71) Applicant: Eric Koenig, Huntington, NY (US)

(72) Inventor: Eric Koenig, Huntington, NY (US)

(21) Appl. No.: 14/237,654

(22) PCT Filed: Mar. 14, 2011
(86) PCT No.: PCT/US11/00464

§ 371 Date: Feb. 7, 2014

(51) Int. Cl. A63F 13/30

(52) U.S. Cl. CPC A63F 13/12; A63F 2300/5506
USPC 463/32

(57) ABSTRACT

A method of delivering sponsor advertising content via sponsor-configured cube-centric games includes configuring a game template with sponsor advertising content to create a sponsor-specific cube-centric interactive game application, making at least one sponsor-specific cube-centric interactive game application available for download to user electronic devices and operating the at least one sponsor-specific cube-centric interactive game application in a electronic device during which users interact with a cube-centric graphical user interface (GUI) to play the game while the sponsor specific advertising content is delivered.

### BACKGROUND OF THE INVENTION

The present invention relates to advertising content delivered to electronic devices broadly and, more particularly relates to a system and method that enable sponsors to configure a game template (wherein a geometric shape is centrally featured) with advertising content thereby creating a sponsor-specific downloadable game, for online or off-line gameplay. The games so created inherently deliver the sponsor-configured content to players through their respective devices during gameplay, thereby increasing brand awareness of the sponsor. The content may comprise sponsor incentives and promotions embedded in the game structure in the form of tangible rewards delivered to the game player in the form of products, discounts, redeemable credits, etc.

Systems and method for providing advertising content in association with games are known.

For example, US Patent Appln. Ser. No 2010/0205035, provides a system and method for providing advertisements in virtual environments. U.S. Pat. No. 7,698,178, provides an online game advertising system. U.S. Pat. No. 7,054,831, provides a system & method for combining and interactive game with interactive advertising. US Patent Appln. Serial No. 2009/0227378, provides a dynamic advertising system for interactive games. U.S. Pat. No. 6,928,414, presents an advertising method using a game program on the Internet & method for Executing the Game Program having the advertisement according to the advertisement method. U.S. Pat. No. 6,882,978, provides apparatus & method for executing a game program having advertisements therein. US Patent Appln. Ser. No. 2004/0248649, discloses a three-dimensional interactive game system & advertising system using the same. U.S. Pat. No. 6,616,533, discloses providing advertising with video games. U.S. Pat. No. 6,036,601, provides a method for advertising over a computer network utilizing virtual environments of games.

While all of the known prior art systems and methods provide advertising content somehow in cooperation with a game, none disclose a platform that allows an advertiser or sponsor to configure a game template that defines a game having a central scheme based on a geometric object that is manipulated during gameplay, and, therefore, generic in one sense but specialized or proprietary in the sense that it presents the pre-configured sponsor-specified or sponsor-controlled content to the users as the play (interact/interface with) the game(s) on their device(s). Users playing a sponsor-defined game interact not merely with the game in one sense, but with the sponsor in another sense.

### SUMMARY OF THE INVENTION

The present invention provides a novel and non-obvious improvement in the art of sponsor advertising content delivery to users by gameplay within electronic devices.

The invention comprises an operating system or platform, preferably operational within a server, that enables brands and advertisers (used with “sponsor(s)” interchangeably herein) to reach participating consumers in an engaging and immersive experience of games thematically related to a central object having a variety of geometric shapes, e.g., a cube-centric game, which game experience delivers advertising content during gameplay that is defined by the sponsor within the confines of a configurable game template. That is, the geometric shape-centric games are configured by the sponsors, using a game template into which the sponsor embeds their advertising content. Once the game template is completed, and tested, the game is downloaded or played via a web browser/transmitted via satellite to a user's electronic device whereby the shape is presented on a display device and manipulated by the user in the context of the gameplay associated with the particular game template configured.

The server or platform, therefore, enables sponsor configuration of an application (“App”) for an electronic device with internet capability (e.g., mobile phone, Smartphone, electronic tablet, PDA, desktop computer, laptop computer, game console, portable game console, TV, web TV, etc., without limitation, based on a virtual object of some desirable geometric shape, for example, by use of a virtual cube as the focus of a cube-centric game.

The App when configured implements two functions. A game function enables the electronic device user to play any of a plurality of simple games built around the particular virtual shape that is the focus of the game functionality, e.g., a cube. An advertising function delivers sponsor-defined advertising content (defined during the configuration stage) in practically any form, as the games are played, limited only by inherent limitations of a multi-faceted virtual geometric shape, or virtual cube.

The two functions are inherently intertwined, as the game features are content driven. Of course as described, the content is provided by the sponsor during the configuration of the sponsor's specific geometric shape-based game template, via the graphic user interface (GUI) presented to the sponsor during configuration. That is, the system architecture, operational at the server, provides the various interactive display screen to the sponsor during configuration of their specific games.

In a preferred embodiment, the game template and game are cube-centric, interactive games that provide for the presentation of multiple interactive gaming surfaces to the user during gameplay by virtue of each cube's six (6) sides or faces. But the invention is not limited to cube-centric themes. Hence, while the detailed description will describe a preferred embodiment of the game, the game template and the process for sponsor configuration of same in detail with respect to a cubic geometric shape (i.e., a cube-centric game and game template), such explanation is for explanatory purposes only.

The invention is not limited to a cube, etc, but the game may take the form of any geometric shape without deviating from the scope and spirit of the invention. By promoting a sponsor's products via sponsor-specific, downloadable game applications thematically related to a geometric shape such as a cube, from which the sponsor-defined content is delivered during through player interaction with the shape's form as rendered on screen, sponsors can be sure that the players will fully embrace their promotional content, if not respond to embrace the products or services intended to be advanced thereby, via an opt-in profiled matching system. Use of the term downloading herein should be understood to also mean operating the game programs directly at the server instead of within the electronic device.

The consumers first “pull” the cube-centric game applications of their choice from a virtual store, the server, a sponsor website or some other dedicated website based on a particular game's the sponsor-defined game features. For example, games might be delivered to users via an opt-in profiled matching system (e.g. like recommendation services such as TiVo and Apple's iTune's “Ping” social music feature) operational at a website dedicated to same operation. This may happen via a variety of ways. In one instance, the user's personal profile information (e.g. age, gender, geographic location, hobbies, interests, etc.) may be stored within their electronic device memory, and then sent to the website's server via an Internet connection, as it is captured.

In another method, the information from the user might be stored in their electronic device memory and then sent directly back to the website, or sponsor website at a predetermined tine, via an Internet connection. Once downloaded to a user's electronic device, the user may play the game online or off-line. If played off-line, the sponsor-configured content is static in a sense that it is fixed. But while the sponsor-specific content is preconfigured, playing a game in a live session allows the server, i.e., the advertiser or its agents, to “push” varying advertising and promotional content to the active game in accordance with the feature definitions made while configuring the various game template forms.

As the user interacts with the active game, for example, by activating features by making game specific movements, gestures, or touches within the faces presented by the GUI as the game is played, or by moving the device in specific directions, as the case may be, new content (proportional features, updates, sales information, sponsor public relations data, etc., without limitation) are delivered to the user's device. Preferably, the users establish their personalized profiles, based upon their likes and interests, which is then stored in relation to the geometric shape. For example, in one embodiment, a game cube becomes the user's virtual cube—personal data bank. In this specific embodiment, the user's personal data bank must be filled with their personal profile information, and same user profile information is made available to the sponsor. The sponsor then utilizes the profile information to deliver the varying proportional features, updates, sales information, sponsor public relations data, etc., through the external faces/planes of the virtual shape based upon these known user interests.

Put another way, this embodiment provides that the substance of a sponsor specific game are downloaded to populate the user's proprietary shell, regardless of shape (to which is linked the user's profile data), and then during on-line game play, the form of the content is flexibly delivered. The possibilities of content delivery for this type of on-line application are limitless.

If an electronic device does not include an accelerometer, the movement-centric game features may be implemented using a sliding or tapping (in a rotational/diagonal/motion, etc.) touch across the touchscreen, a sliding movement of a mouse or other input device, etc.

The incentives for social collaborative gaming interaction amongst a network of users may be provided in a variety of options. For example, the initial user may receive a certain discount on sponsored products or a certain amount of redeemable credits to be applied to sponsored products at the time of purchase. These credits may be stored in a virtual “pool” or “bank” from which the user may retrieve them at the time of product purchase. They may use these credits themselves or “gift” them to others so they may apply these credits to sponsored products (e.g. like as done in the iTunes store).

As part of the user's profiled account, they would be able to check their “credit” balance and purchase history, as well as utilize this display to transfer “credits” from their account to that of another user.

The incentives may increase for the initial user dependent upon a number of factors, including but not limited to: How long they play the game; How often they play the game; How far they advance in the game; How many others they share the game with; and How many others those people share the game with. Like these credits, the invention tracks every input by the user and makes same available to the sponsor. If the user is part of a team of users participating in the same game, they may each receive their discount, credit, or other incentive based upon the quantity of the team.

Icons may be hyperlinks, or keys to advancing in the game or receiving additional content for the user, which may be in the form of rewards for continued game play. In more detail, by activating an icon (during online play), the user is either automatically linked to a store of new sponsor data for download at the server, or automatically linked to the sponsor website, either directly or through the server. In this way, the sponsor may continuously update the original data input into the game template during the configuration stage, as well as take advantage of change user/game player circumstances, such as geographic location, time of day, etc.

The links may precipitate direct download of additional sponsor material in addition to that delivered in accordance with the pre-configured game template. For example, banner ads that are always visible or visible for limited times, e.g., slim ads that obscure a fraction of the screen, may be downloaded to add further content. Interstitial full-page ads may be arranged to pop up between turns of the faces of a shape, e.g., a cube, during a game or with progression of a player along a theme-based game board path, e.g., filling all or part of the entire face currently presented in a screen.

As mentioned above, sponsored promotional adds to advance a new sponsor product, post configuration may be utilized to enhance a game's effectiveness. As such, there is a game for every sponsor available at the server-driven website. A user selects a game to download based upon their interests or is suggested to them via a profiled recommendation service, e.g. Ping, TiVo, etc., where would comprise context upon which advertisers or sponsors can opt-in.

These recommendations may be based upon the user's profile which will automatically be adjusted via an adaptive logic, dependant upon what content the user interacts with and how the user interacts with the content.

For example, there might be a game proprietary to Adidas, Nike, Capital One, Nissan, The Home Depot, etc. Also, the apps may be co-sponsored, and promoted by multiple advertisers/brands. This may be accomplished by the user selecting from the templates available on the server, then deciding what content to apply to the selected game template. Once this step is complete, the specific game is made available to the user via the server from which they can actively pull it, or it is pushed to their device via the recommendation service, based upon the user's profile. The advertising viewed by and/or interacted with by the user might be a logo, product image, promotional code, URL to an online store or brand website, or clue to be used in the gameplay. This is made possible during the game building process, wherein the sponsor determines which components to place within the template for distribution to the user. In this sense, the cube from a sponsor perspective, may be said to be “fully immersive algorithmic,” i.e. the inside of the shape corresponds with the outside of the shape and makes the whole. As used herein, “super-learning” is meant to convey conditioned reflexive learning by the repetitive sensory input of motion, shape, color, etc.

In order to configure their specific game, sponsors would utilize the following process. First, the sponsor would register with the game template server and create a unique user account for their brand, which they may utilize each time they wish to create another game by simply logging in to the server using their account information. This initial registration process may include the sponsor providing such information as, but not limited to, the name of the brand/company, their contact information, contact individual, associated brands/products, etc. After this step, the sponsor will be asked to select which genre of game they wish to utilize, including but not limited to action games, adventure games, action-adventure games, role-playing games, life simulation games, vehicle simulation games, strategy games, music games, party games, board games, puzzle games, trivia games, and sports games.

The sponsor is then presented with a series of templates from which they can render their specific game. This may include selecting which geometric shape to utilize and how many sides will be dedicated to advertising and how many will feature the game play components. They will also be asked to determine how many players may play the game at one time (i.e. single player, multi-player, team, etc.). A series of other questions/options will follow to help the sponsor render their game, including but not limited to: will there be a fee to download the game, will there be a fee to continue playing the game (i.e. a subscription), will there be a fee to purchase content or elements during the gameplay (i.e. micro-transactions), etc. The sponsor will also be asked how many products they wish to promote (i.e. a single product, a line of products, or a plurality of product lines).

Once they have done this, they will be presented with a virtual facsimile of their game template, so they can then drag-and-drop the unique components to each face of their game template. This will be determined by what genre and type of game they selected during the initial steps. The user may upload to the server all required media and materials for applying to the template, and then select which elements to apply to which face, in accordance with the selected game template.

For example, on a first face dedicated as the home screen the sponsor would place the title of the game, which may or may not include the brand's logo. On a second face dedicated as the product screen, the sponsor would place a variety of products that they wish to advertise to the user (this may be one line of products, a variety of product lines, etc.). On a third face dedicated as the selection screen, the sponsor would enable the user to select which of the sponsored products the user feels are best suited for a specific given criteria (e.g. which tires work best on a certain terrain, which jacket best protects from certain weather conditions, which shampoo best treats a certain type of hair, etc.). On a fourth face dedicated as a map, the sponsor may be either allow the user to locate where they are virtually within the scope of the game or where they are physically in “real life” (e.g. via a service such as Google Maps). On a fifth face dedicated as a video display screen, the sponsor may enable the user to see the products in action, either in a computer rendered animation or a real life video clip (this video may be related to the game, or just as a promotional tool for the sponsor's product). On the sixth face dedicated as a shop or commerce screen, the sponsor would provide to the user some incentive to purchase the sponsored products (e.g. a link to an eCommerce website, a coupon with promotional code to redeem a discount to purchase sponsored products, or the address of a physical retail location (this may be determined by the user's proximity to an associated retail location that sells the sponsor's products).

After the sponsor has completed the template for their specific game, they will be enabled to review the template before uploading to the server so as to enable the user to download said sponsor-specific game to their electronic device.

In addition, the cube-centric games allow for collection of data for sponsors to track results, i.e., how many times their apps are downloaded, which products the users interact with, where (geographics), by whom (demographics), etc. This is accomplished in a variety of ways. For example, the user's information may be stored within the device's memory, and then sent to the server via an internet connection. In another method, the information from the user is stored in their device's memory and then sent directly back to the sponsor via an internet connection.

The system includes a server, bank of servers in one physically connected network, or a network comprising servers located at various locations, managed by a master server. The server or servers store demographic and psychographic user profile data for each participating consumer in a database that is accessible to the sponsors.

In a method embodiment, the invention includes configuring a game template with sponsor advertising content to create a sponsor-specific cube-centric interactive game application, making at least one sponsor-specific cube-centric interactive game application available for download to user electronic devices and operating the at least one sponsor-specific cube-centric interactive game application in an electronic device during which users interact with a cube-centric graphical user interface (GUI) to play the game while the sponsor specific advertising content is delivered.

The present invention, in one embodiment, relies on a social cooperative gaming model for the viral marketing of the sponsor-specific games. To achieve this, every game would have a tangible value (in the form of either points, discounts, promotions, or a combination thereof). Participants can send games to their friends in an incentive driven transmission. This creates a “multi-level marketing network” based on discounts/incentives provided by the sponsor which translate to cost saving on product acquisition, redeemable only upon purchase. By enabling the social cooperative gaming model, and creating a multi-level marketing network, the system provides for the viral marketing of the game and the resultant proliferation of the game amongst a group of users.

For example, just by playing the game a user might begin with a 10% discount on the purchase of a sponsored product, which they can then increase by doing well, and/or by sharing the game with others. In another example, if a user passes the game along to another user, they may receive a $5 cash commission, or a 5% cash commission dependent upon purchase price.

In one embodiment of the social cooperative gaming model, an initial user begins active interaction with the sponsor-specific geometric shape-based game. Once they reach a point in the game, or they do not wish to continue that part of the game, they can “pass” the game off to another user via a certain gesture [e.g. flipping the geometric shape, rotating the electronic device, pressing a button (virtual or physical), etc.]

A secondary user then receives an alert, e.g. a text message or email, letting them know they have received the initial user's game invitation (or, if they are already playing said game, a cooperative request to join them at the desired game level). The secondary user can then pick up where the initial user left off, in essence viewing the same side of the geometric shape the previous user was viewing before they passed it off.

Users who do not wish to participate in a game they have been invited to interact with may still receive the benefits of the incentive. If a user receives an invitation for a game that does not interest them (either from the server or another user), they can in turn pass it off to someone they know who might want to participate.

In this event, the passive player might receive a lesser incentive just for sharing the game, in the form of a reduced percentage discount or fewer number of credits to be stored in their “pool” or “bank”, as a reward for passing on the advertisement to individuals who might be interested in that particular advertisement (even if the original recipient is not).

### BRIEF DESCRIPTION OF THE DRAWING FIGURES

The present invention can best be understood in connection with the accompanying drawings. It is noted that the invention is not limited to the precise embodiments shown in drawings, in which:

FIG. 1A depicts one embodiment of a cube of the invention, where the first five faces are dedicated solely to the game and the sixth face dedicated to advertising during cube-centric gameplay;

FIG. 1B depicts the cube as it is spun by the user using an input device such as a joystick or accelerometer;

FIG. 1C depicts a geometric shape that is not a cube, for example a pyramid;

FIG. 1D depicts the cube as it is spun by the user using an input device such as a joystick or accelerometer;

FIG. 2 depicts a cube embodiment that utilizes all 6 faces for gameplay, where advertising content is displayed in an “extra” face between each of the six dedicated faces during the cube face rotation during gameplay;

FIG. 3 depicts one embodiment of a system for delivering advertising content of the invention;

FIG. 4A depicts a hand-held electronic device, e.g. a Smartphone;

FIG. 4B depicts an exemplary hand-held electronic device which may be used in accordance with the invention;

FIG. 5 depicts the functional blocks comprising one embodiment of the server platform of the invention;

FIG. 6A depicts one embodiment of a game template of the invention;

FIGS. 6B-6G depict various display screens that are presented to users as they interact with the FIG. 6A embodiment;

FIG. 7 presents one example of functional flow required by a sponsor in their process of configuring a cube-centric game template of the invention;

FIGS. 8A, 8B, 8C, 8D present various display screens presented to sponsors to enable the sponsor to choose a game genre, select a template, define their game materials and perform a template review;

FIG. 9 depicts the functional flow of how the viral proliferation of the game might be spread amongst a group of users;

FIG. 10 depicts a display screen presented to users to enable them to activate the GPS-functionality, if available, within their device; and

FIG. 11 depicts a display screen presented to users with an example of a unique promotional code which they may redeem at time of purchase of sponsored product.

### DETAILED DESCRIPTION OF THE INVENTION

The following is a detailed description of example embodiments of the invention depicted in the accompanying drawings. The example embodiments are in such detail as to clearly communicate the invention and are designed to make such embodiments obvious to a person of ordinary skill in the art. However, the amount of detail offered is not intended to limit the anticipated variations of embodiments; on the contrary, the intention is to cover all modifications, equivalents, and alternatives falling within the spirit and scope of the present invention, as defined by the appended claims.

As described above, the invention is directed to an application for geometric-shape centric game, configured by a sponsor using a game template by which their content is entwined with shape-based game features, which content is thereafter delivered to a game player as he/she manipulates the virtual shape during gameplay.

In a preferred embodiment, the invention comprises a cube-centric game. The sponsor interacts with an operating system or platform that is operational in a server to configure a cube-centric game. After being configured and tested, the games are downloaded to electronic devices with internet capability (e.g., mobile phone, Smartphone, tablet, PDA, laptop computer, desktop computer, game console, portable game console, portable TV, etc., without limitation), and operate them by some type of input device that cooperates with the interactive graphical user interface (GUI). Use of the term downloading herein should be understood to also mean operating the game programs directly at the server instead of within the electronic device. Game icons may be used as part of the games, or as links to further sponsor content delivery features or communication links, limited only by the templates.

The sponsor, by completing the template, will assign various branded content to the sides of the geometric shape. This may be as a logo or other graphic, a products or plurality of products, as a video featuring the sponsored product, as a link to purchase sponsored products, etc. Once the game has been downloaded to their device, the users open the game and are presented with one face of the geometric shape. They then engage in the gameplay experience, and are required to rotate the shape to view the other sides/faces.

Each side/face corresponds to a different element of the game, and may present a different form of advertised content to the user (e.g. a full page ad, a branded image with sponsor's logo, a sponsored product, etc.). This rotation of the geometric shape may be accomplished by touching a touchscreen, by moving the device (which engages an internal component, such as an accelerometer), or through some other input device, such as a keyboard, mouse or remote control.

When games are used in an electronic device comprising a touch-screen display, both cube movement and icon link/app activation are touch implemented. The graphical user interface (GUI) provided to enable gameplay, however, may be controlled by trackball, keypad, mouse, keyboard, remote control, or any other type of input device, without limitation. In an embodiment, user interaction further relies on the movement (i.e. directional motion and force) of the device, via an internal component of the device, e.g. an accelerometer.

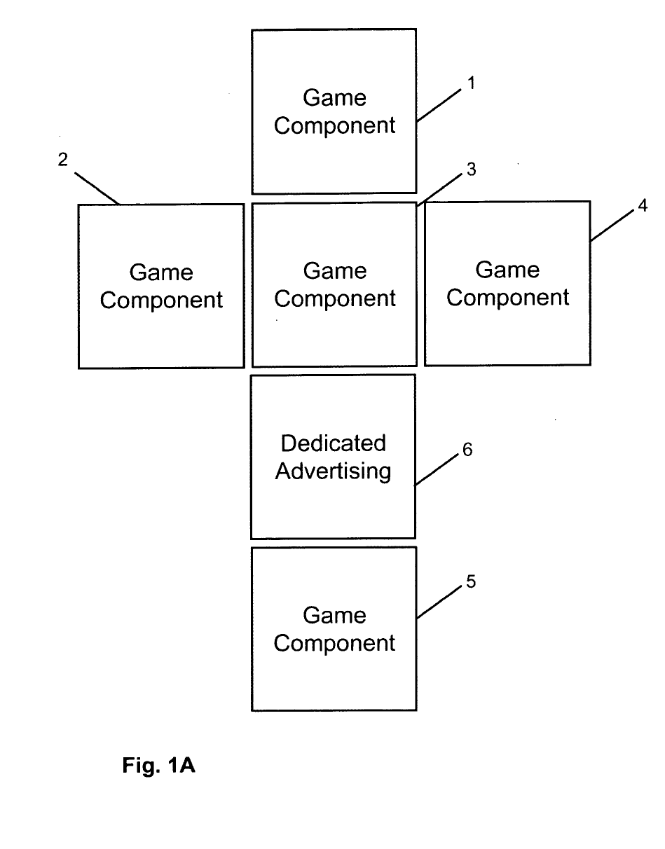

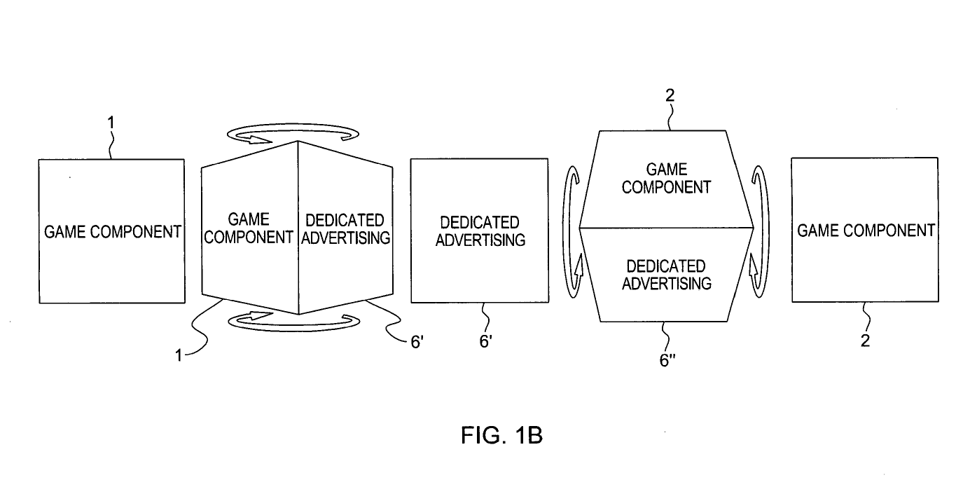

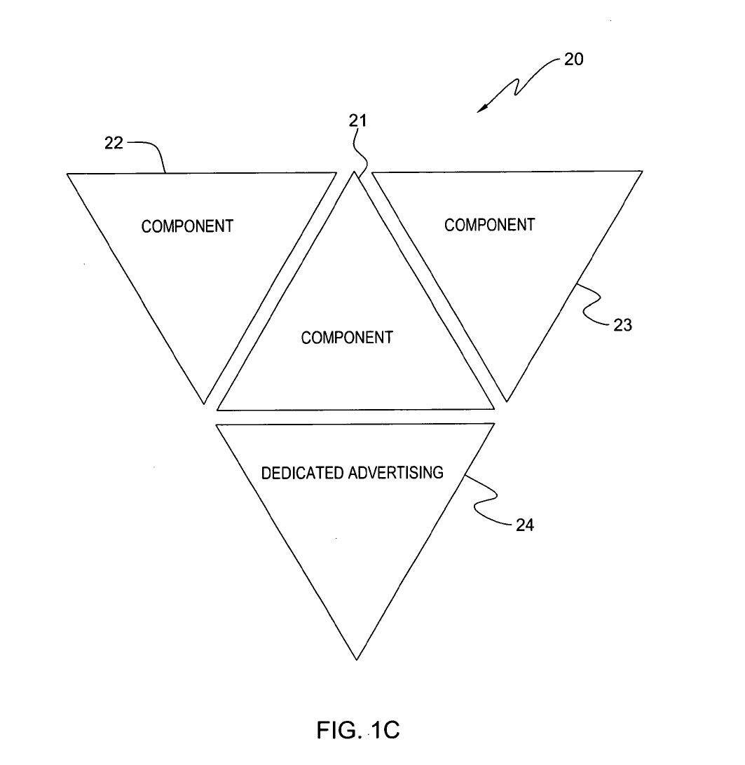

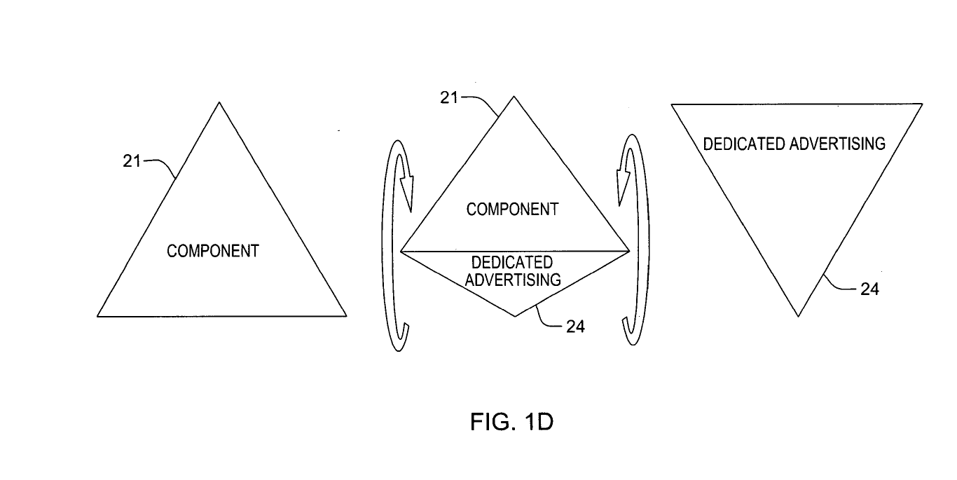

FIG. 1A herein highlights the six faces of a cube 10, which is utilized to define the theme of the cube-centric game, the preferred embodiment of the invention. The cube 10 comprises five faces 1, 2, 3, 4 and 5 dedicated for gameplay (and configured by a sponsor with advertising content to define a game), where a single face 6 is used only for advertising. In accordance with one embodiment of a template, one face 1 may embody a home screen, one face 2 may embody a product display screen, one face 3 may embody a product selection screen, one face 4 may embody a map and one face 5 may embody a video display screen.

FIG. 1B depicts the cube in a sequence of positions as it is spun by the user using an input device such as a joystick or accelerometer. The first cube position (moving left to right in FIG. 1B) in the sequence shows face 1, which is a game component. The user then spins the cube towards a face (undefined as of yet), indicated by the transition or second sequence position. Therein, part of both face 1 and the advertising interspace 6′ are shown. The third sequence position depicts the advertising interspace 6′ alone, i., the dedicated advertising. The fourth sequence position shows the cube after being spun down from the advertising interspace 6′ towards face 2. Therein, part of both advertising interspace 6′ and face 2 (a game component) are shown. The last sequence position shows face 2, the end position of the two spins.

FIG. 1C depicts a geometric shape that is a pyramid 20. The pyramid shape is used to define the theme of a pyramid-centric game. The pyramid 20 comprises three faces 21, 22 and 23, dedicated for gameplay (and configured by a sponsor with advertising content to define a game), where a single face 24 is used only for advertising. FIG. 1D depicts the pyramid in a sequence of positions as it is spun by the user using an input device such as a joystick or accelerometer. The first pyramid position (moving left to right in FIG. 1D) in the sequence shows face 21, which is a game component. The user then spins the pyramid back towards the sole dedicated advertising face 24, indicated by the transition or second sequence position. Therein, part of both face 1 and the advertising face 24 are shown. The third sequence position depicts the advertising face 24 alone.

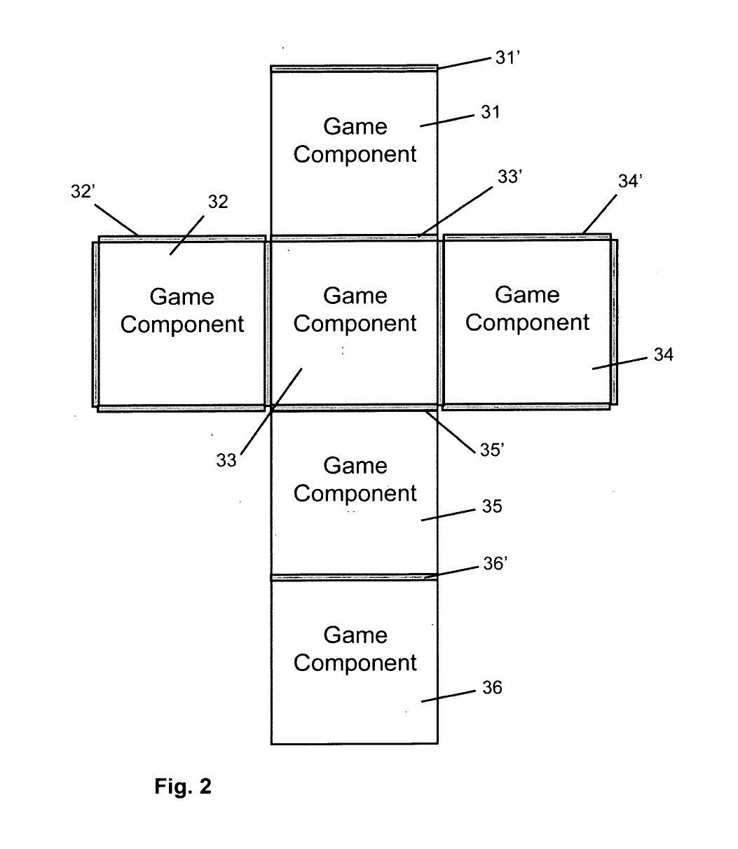

Another embodiment of the invention, shown in FIG. 2, utilizes all 6 sides of the cube 30 for gameplay, whereby the advertising is displayed in between each face (31-66) during the rotation of the cube (“multi-faceted cube”). That is, as each face (31-35) of the cube is manipulated to cause it to rotate, and a new face appears. The advertising content is presented after the first screen disappears but before the next screen appears. It may be said to be in the interspaces between each game component face. The advertising interspaces are indicated as element 31′, 32′, 33′, 34′, 35′ and 36′. The advertising content, therefore, may be said to be virtually “living” in the seams between the sides.

The game and advertising delivery processes are intertwined. Put another way, the gaming process is the advertising delivery process. Advertising could depend on a variety of factors, such as user's personal preferences, age, gender, location (proximity advertising), etc., fed back to the advertiser during online play in a “live” play configuration. Alternatively, the advertising content may be decided based upon a specific advertiser sponsoring the cube (dedicated during configuration, which does not change during intended off-line play therewith). The advertising may be related to the content of the game, or may be unrelated. The invention enables multiple game genres (action games, adventure games, action-adventure games, role-playing games, life simulation games, vehicle simulation games, strategy games, music games, party games, board games, puzzle games, trivia games, and sports games).

In the online embodiment, the state of interactive gaming is constantly evolving. Please note that the examples depicted herein are for exemplary purposes only and are not meant to be limiting in any way. Other genres might exist presently or in the future which might be utilized in accordance with the invention.

A sponsor may insert icons into any game component face, or any dedicated advertising face that immediately link the user to a sponsor website. Icons may be hyperlinks, or keys to advancing in the game or receiving additional content for the user, which may be in the form of rewards for continued game play. For example, in a puzzle game, specifically a casino type game with a slot machine type interface, a user operates through the GUI to spin the geometric shape to align various icons. The alignment of these icons will then yield to the user advertisement from the sponsors.

In one embodiment of a cube-centric game, the faces of said cube each contain a plurality of icons which may represent sponsored products, numerical values, or some other image. When the cube is spun, either by moving the electronic device in a certain motion, by touching the screen, or some other manner, the icons would individually rotate as they as if they were the individualized cubes that make up the total of a Rubik's Cube™. Once the icons have ceased rotating and come to rest, the displayed image (i.e. certain sequence or order of icons) would yield to the user a certain incentive. For example, if the sponsor is an athletic apparel marketer, and the icons represent a plurality of sneakers, the user would rotate the cube via the certain gesture and once the icons came to rest and displayed, for example, two pairs of one style of sneaker and one pair of another style, the user may be entitled to 10% of the sneaker show in the two pairs, but if they displayed three pairs of one sneaker style, they might receive 20% off that style. These and like functions are all defined by the sponsor during the template configuration process.

In an embodiment, the geometric shape may feature the advertising internally, within the cube, only visible while the cube is being rotated (i.e. the faces become transparent, revealing the advertising element within). The internal advertising information will be provided for by the sponsor in the creation of their game, via their implementation of the game template. They may elect not to include internal advertising elements, instead opting to just limit the advertising to the exterior of the geometric shape, but this decision will be made during the game creation process.

In another embodiment, the interior of the geometric shape features a visible representation of the personal information as provided by the user. This information is stored in the user device memory and then uplinked to either the server or directly to the sponsor. In more detail, the user enters this information in a user profile menu (e.g. age, gender, geographic location, interests, hobbies, favorite items, etc.), which is displayed visually to the user within the shape via the GUI function. The sponsor processes the received user information and determines what content to lace on the exterior of the shape thereby. This user-specific sponsor defined content is then downloaded to the virtual shape for display during the online gameplay.

As the user engages with the game application, the advertisers/sponsors can track a variety of useful information based upon the user's interaction with their app, e.g., how long do the users play the game? which products is a user choosing to view during game interaction? which products is a user selecting for purchase? how much time is a user spending viewing a particular product? how much product information is a user retaining? which demographics are utilizing a specific game application more? These and like functions are all defined by the sponsor during the template configuration process.

A component of the software utilized to run the game on the user's device tracks all the aforementioned information and then stores it, along with the user's personal information, in the device's memory. At set intervals, this information is then relayed back to the server, or directly to the sponsor. The sponsor can then utilize this aggregate of information to better distribute its advertising content to users. The user may configure their profile prior to the download of their first sponsor specific game, in order that the server's profiled recommendation service can suggest suitable games to the user without the need to actively engage in a game.

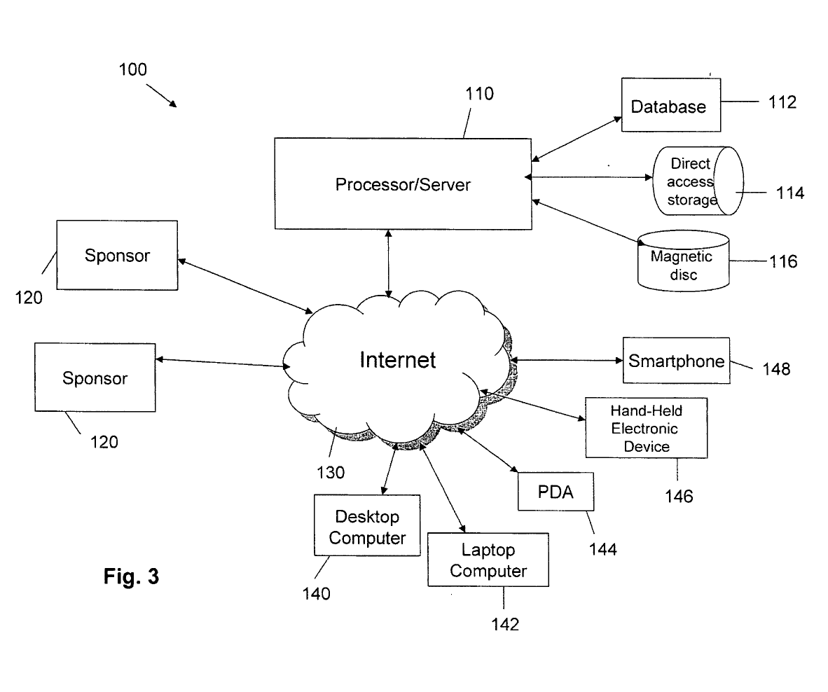

FIG. 3 defines a system (100) for delivering advertising content via sponsor-configured cube-centric games. The system includes a processor/server (110) is programmed to enable sponsors to interface with and configure a game template to create a cube-centric interactive game application embedded with specific sponsor advertising content. The processor/server includes a memory (not shown in FIG. 3) for storing the program instructions comprising the system platform. The processor/server is shown connected to a database (112), a direct access storage device (114) a magnetic disk storage device (116), and to the Internet (130). While these connects are indicated in the figure to comprise hardwire, they also may be wirelessly connected. For that matter, while shown as a standalone device, processor/server (110) may be part of a network connected to the Internet via some sort of network gateway device.

The processor/server may be accessed via sponsor devices (120) through the Internet (130). The processor/server includes a communication function and a graphical user interface function to allow the sponsors to access the server, and server-stored game templates to configure same to realize respective sponsor-specific games. Once the games are configured, they are stored and made available to the electronic devices of users, i.e., desktop computer (140), laptop computer (142), PDA (144), Hand-held electronic device (146), Smartphone (148), without limitation, via the Internet. The games are downloaded enabling interactive gameplay via a graphical user interface (GUI) operational in the user device during gameplay while receiving the advertising content.

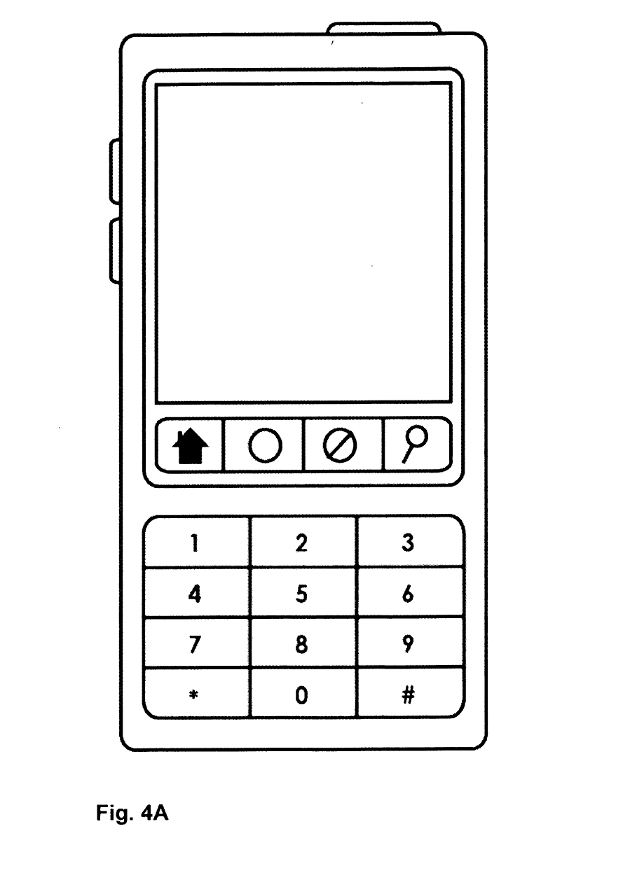

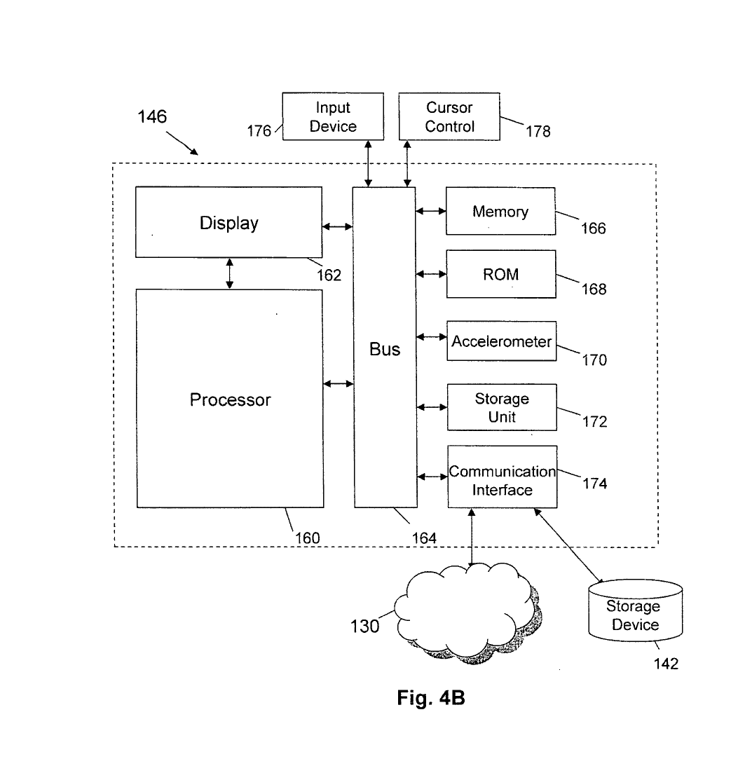

FIG. 4A is depicts one form of a hand-held electronic device (146).

FIG. 4B is a system block diagram of the hand-held electronic device (146) within which the sponsor-configured games are operational, in accordance with the invention.

The electronic device (146) includes a bus (164) or other communication mechanism for communicating information. The electronic device (146) includes a processor (160) coupled with the bus (164). The processor (160) can include an integrated electronic circuit for processing and controlling functionalities of the electronic device (146). The electronic device (146) also includes a memory (166), such as a random access memory (RAM) or other dynamic storage device, coupled to the bus (164) for storing information which can be used by the processor (160). The memory (166) can be used for storing any temporary information required. The electronic device (146) further includes a read only memory (ROM; 168) or other static storage device coupled to the bus (164) for storing static information for the processor (160). A storage unit (172), such as a magnetic disk or optical disk, is provided and coupled to the bus (164) for storing information.

The electronic device (146) can be coupled via the bus (164) to a display (162), such as a cathode ray tube (CRT), a liquid crystal display (LCD), a light emitting diode (LED) display, or an interactive touchscreen display, for displaying information and receiving user touch inputs, or coupled directly. Alternatively, or in addition, an input device (176), including alphanumeric and other keys, is coupled to the bus (164) for communicating a user input to the processor (160). The input device (or touchscreen) can be included in the electronic device (146). Another type of user input device is a cursor control (178), such as a mouse, a trackball, or cursor direction keys for communicating the input to the processor (160) and for controlling cursor movement on the display (162). Another type of input device is an accelerometer or other motion detection device (170). The input devices (176) and motion detecting device (170) can also be included in the display (162), for example, comprising the touch screen mentioned above.

Various embodiments are related to the use of the electronic device (146) for implementing the techniques described herein. In one embodiment, the techniques are performed by the processor (160) using information included in the memory (166). The information can be read into the memory (166) from another machine-readable medium, such as the storage unit (172).

The term “machine-readable medium” as used herein refers to any medium that participates in providing data that causes a machine to operate in a specific fashion. In an embodiment implemented using the electronic device (146), various machine-readable medium are involved, for example, in providing information to the processor (160). The machine-readable medium can be a storage media. Storage media includes both non-volatile media and volatile media. Non-volatile media includes, for example, optical or magnetic disks, such as the storage unit (172). Volatile media includes dynamic memory, such as the memory (166). All such media must be tangible to enable the information carried by the media to be detected by a physical mechanism that reads the information into a machine.

Common forms of machine-readable medium include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge.

In another embodiment, the machine-readable medium can be a transmission media including coaxial cables, copper wire and fiber optics, including the wires that include the bus (164). Transmission media can also take the form of acoustic or light waves, such as those generated during radio-wave and infra-red data communications. The electronic device (146) also includes a communication interface (174) coupled to the bus (164). The communication interface (174) provides a two-way data communication coupling to the Internet (130). The Internet (130) may be connect via and intervening Bluetooth Pico-net network structure.

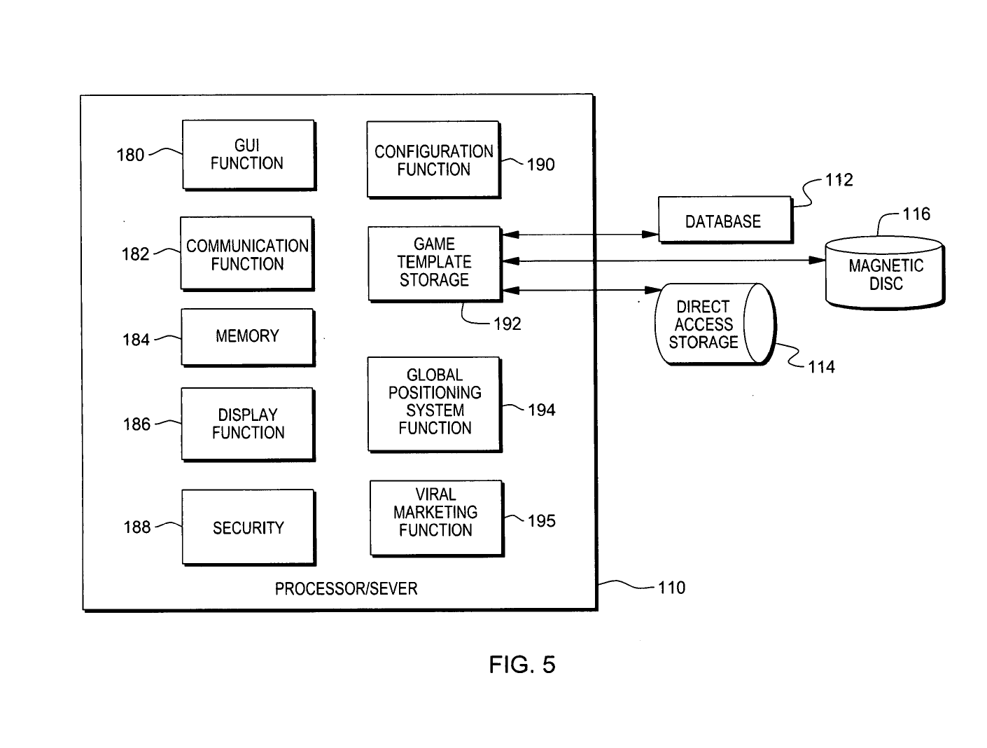

In some embodiments, the electronic device (146) can be connected to the storage device (142) for storing or fetching information. Examples of the storage device (142) include, but are not limited to, a flash drive, a pen drive, a hard disk or any other storage media. FIG. 5 depicts the functional blocks comprising the processor/server as seen in FIG. 3. Shown therein is an interactive GUI function (180), a communication function (182), a memory (182), a display function (186), a security function (188), a configuration function (190) and a game template storage device (192). The game template storage device is shown directly connected to the database (112), the magnetic disk (166) and the direct access storage device (114).

The configuration function (190) controls the overall process of sponsor interaction to configure a game template. The game template storage function is responsible for storing and retrieving game templates, buy sponsor, in any one of database 112, magnetic disc 116 or direct access storage 114. In addition, these storage devices store the rules, and any other data necessary to present to the sponsor to configure a game template.

The GUI function (180) operates to provide interactive display images to the communication function (182), which then transmits the display images to the sponsor device. The GUI receives sponsor input (via the communication function (182)). The sponsor data is stored in a memory (184), for further operation. The display function (186) is responsible for implementing all of the signal processing to enable the virtual shapes to operate in the game applications, once fully configured and downloaded. The security function (180) operates to safeguard sponsor data by implementing role-based access. The security function may be implemented using conventional security means, for example, RSA.

The GPS function 194 operates to identify a location of an electronic device, most likely a handheld electronic device. Location data is sent from the electronic device to the server or the sponsor server using the communication function 182.

The viral marketing function 196 operates to enable players to share various game components and incentives by virtue of creating a linked group of participating users.

In one embodiment, there may be a game in which the user is required to research a collection of sponsored products and select which product might be best suited given a set list of criteria (e.g. location, terrain, climate, time of day, time limit, budget, etc.).

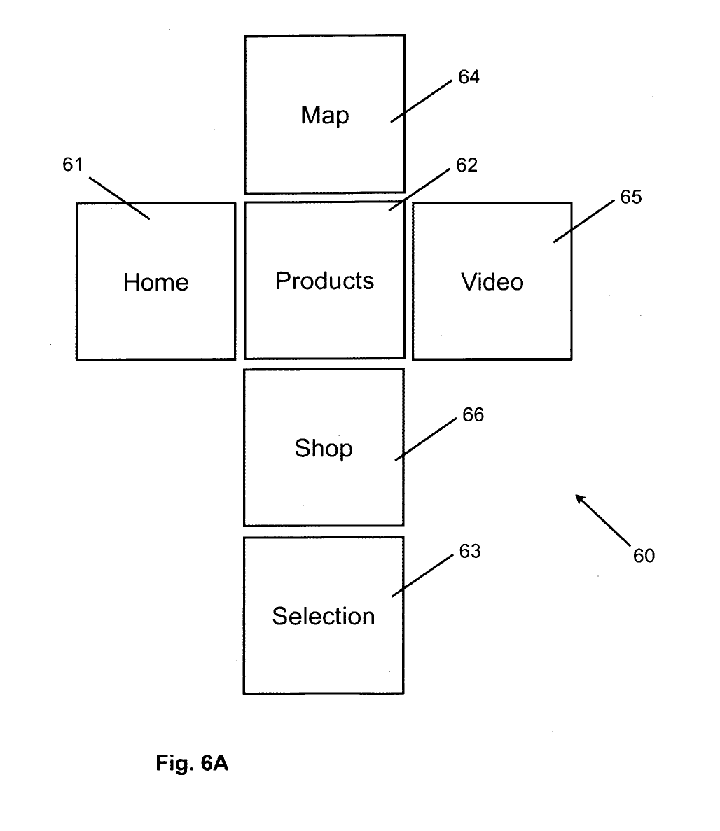

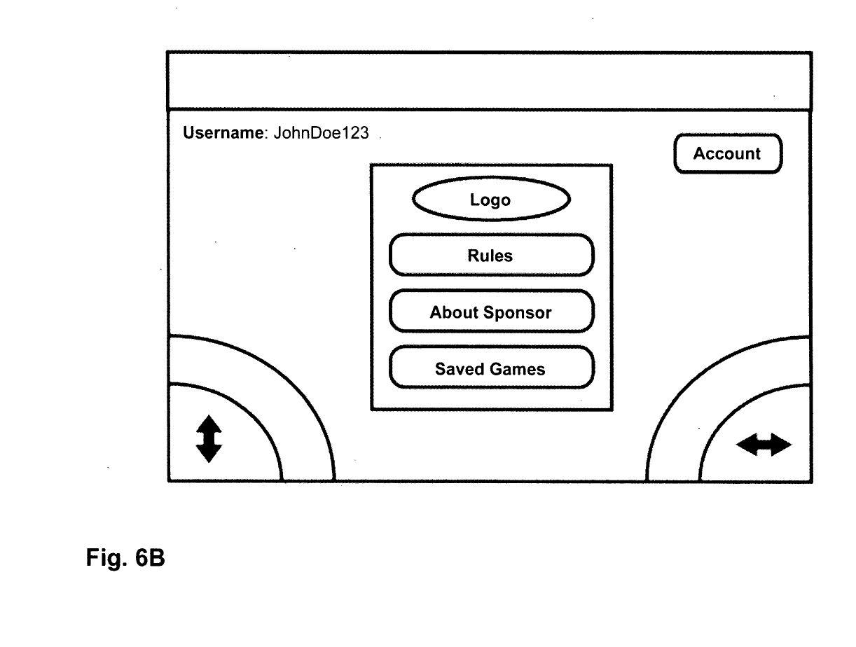

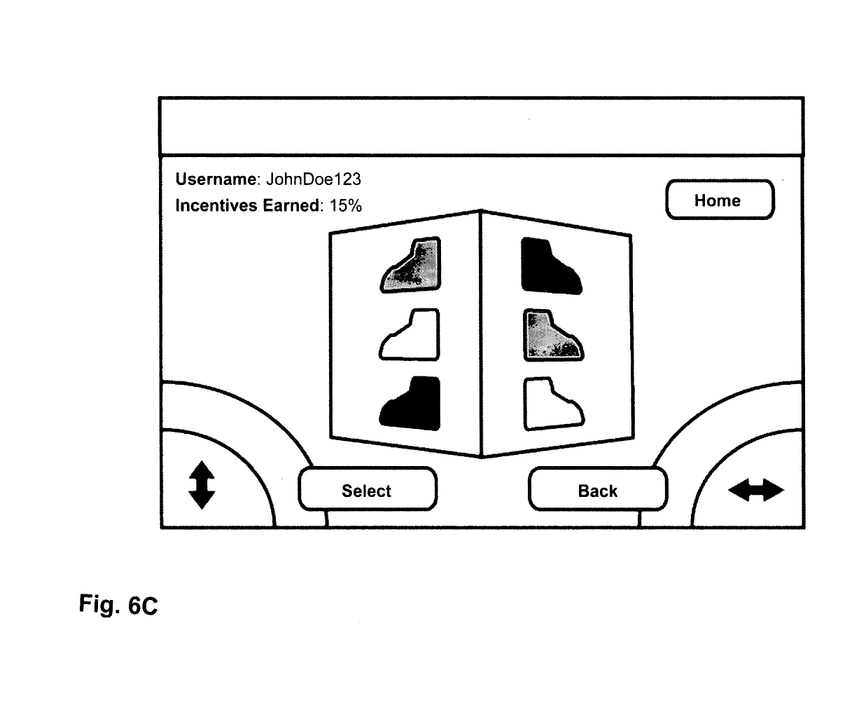

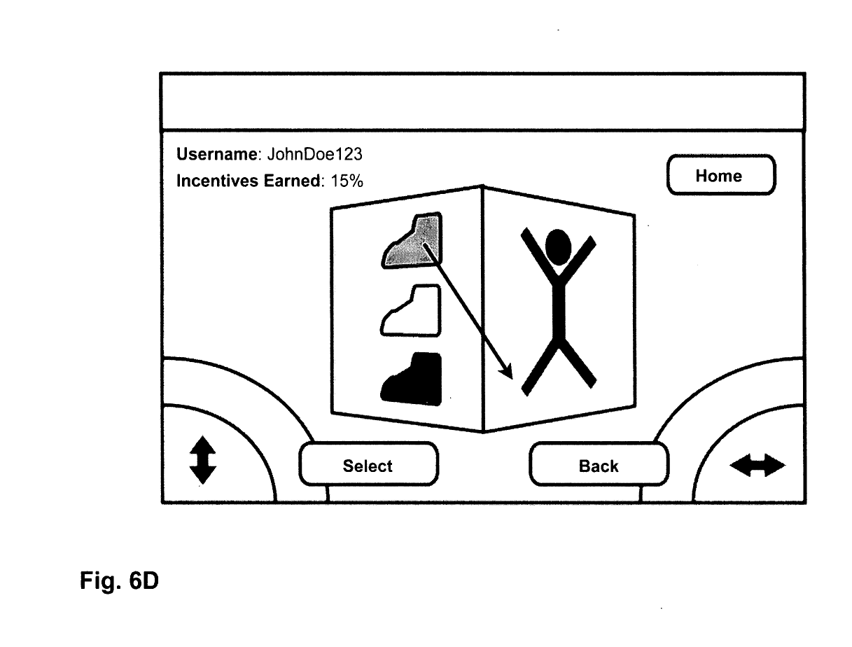

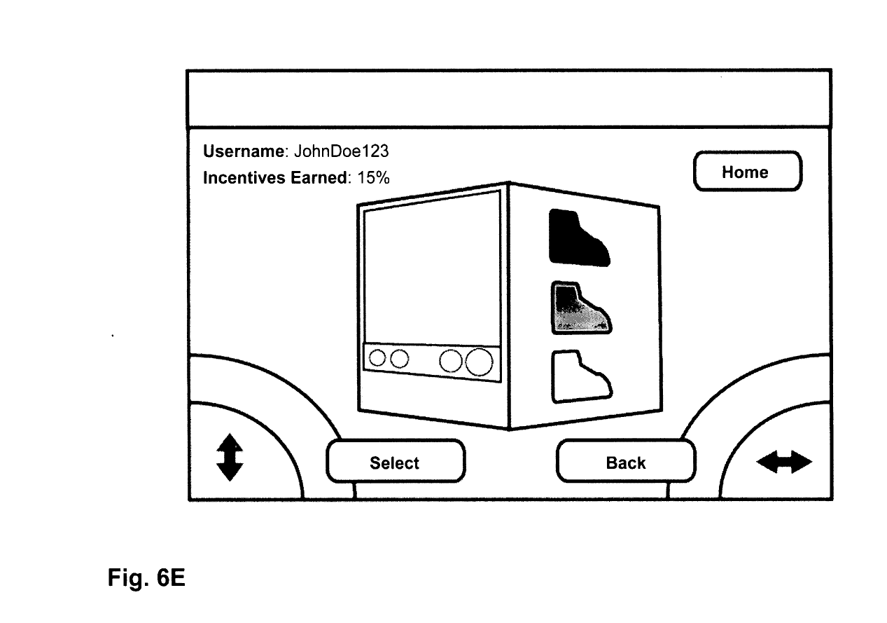

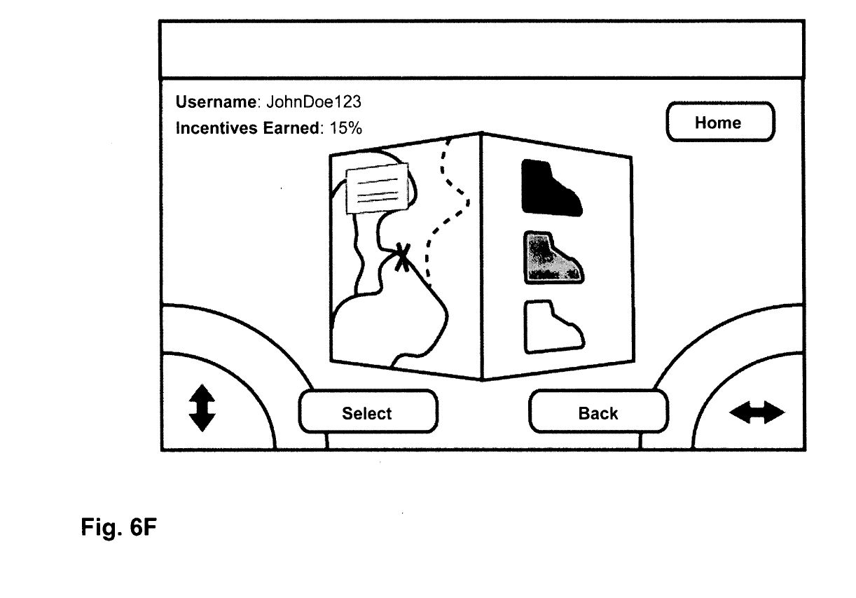

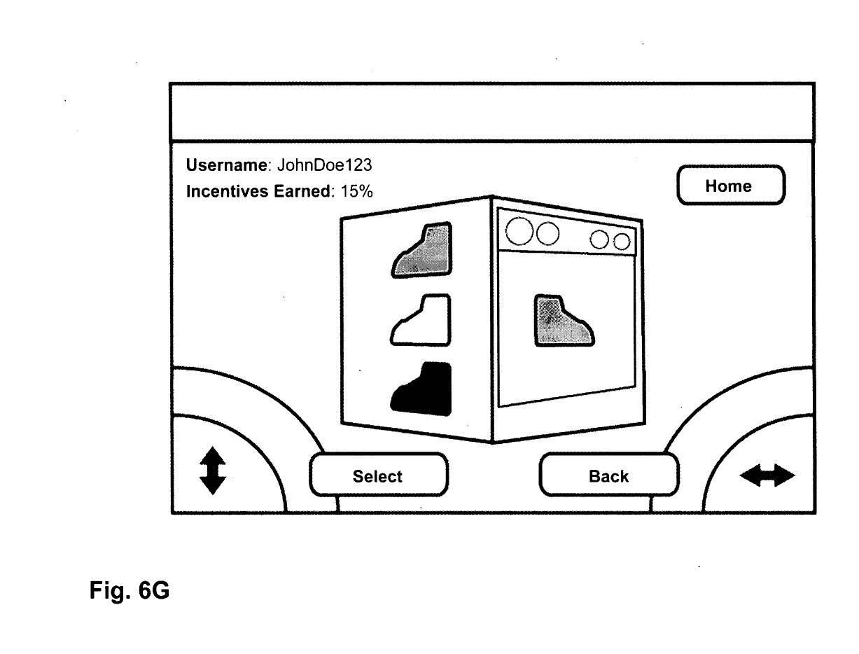

FIG. 6A describes one embodiment of a six face cube template 60. In this embodiment, the faces of the geometric shape will feature sponsor content, which may be implemented as follows. This may be used as a model for the interspace data, described above.

A first face is dedicated as a home screen 61, whereby the user sees the title of the game. This title might include the brand's logo. Also potentially displayed to the user on this screen: menu options (including directions, scores, etc.), profile/account access, etc.

A second face is dedicated as the products screen 62, wherein the user would see a variety of products that the sponsor wishes to advertise to the user (this may be one line of products, a variety of product lines, etc.).

A third face is dedicated as the selection screen 63, wherein the user chooses which of the sponsored products they feel are best suited for a specific given criteria. For example, they can choose (depending on sponsor content defining the game at hand) which tires work best on a certain terrain, which jacket best protects from certain weather conditions, which shampoo best treats a certain type of hair, etc.

A fourth face is dedicated as a map, wherein the user may is either required to decide which product to select based upon where they are virtually within the scope of the game or where they are physically in “real life” (e.g. via a service such as Google Maps).

On a fifth face dedicated as a video display screen 65, the user is presented the sponsor's products in action, either in a computer rendered animation or a real life video clip. Please note that this video may be related to the game, or just as a promotional tool for the sponsor's product).

A sixth face is dedicated as a shop or commerce screen 66, wherein the user is provided with some incentive to purchase products. Such incentives might be, for example, a link to an eCommerce website, a coupon with promotional code to redeem a discount to purchase sponsored products, or the address of a physical retail location. This last option is determined by the user's proximity to an associated retail location that sells the sponsor's products, of course during online play where the user's devices includes GPS operation).

In the above-described embodiment, the gameplay may proceed as follows. The user opens the respective application store or marketplace as dictated by their device and downloads the desired game application. Alternatively, the user is sent an invitation by the server to accept a new game based upon their personal user profile, once the user has completed their profile and the same is received by the sponsor or server.

The user then either decides to play the game or not. If they chose to not play the game, they may be asked to “pass” the game along to another individual who may be more inclined to play said game. If the individual to whom the initial user passes the game does elect to play the game, the initial user may be entitled to receive a lesser form of incentive than had they engaged in the game themselves. This may be accomplished by the user's device first tracking any game inventions sent to a user by the server, either directly by the server or from another user, and then tracking the response to that game invitation (i.e. play or not play) by the device's memory. The user's device will also then track whether or not the user sends the game on to another user in the form of a game invention. This data (i.e. the user's response to the initial game invention and whether or not the user sent the game on to others) will then be sent to the server, or directly to the sponsor. Once the subsequent users respond to the initial user's game invitation, that response is then sent to the server, or directly to the sponsor. Once this has happened, the server will then send an incentive to the initial user for any other user who opts to engage in the game, regardless of whether or not the initial user themselves engaged in that game.

If the initial user elects to engage in the game themselves, they would open the app and be presented with the home screen. Following this, they would see a menu which might provide a variety of options, to include but not limited to game directions, sponsor information, high scores, etc., as depicted in FIG. 6B.

Once the user has reviewed the rules and directions, they begin the game play. In one example, the user is playing a cube-based game with 6 faces which contain the sponsor-specific content.

In this example, the user is presented with a scenario in which they need to select the best sneaker to wear when playing basketball on a court in New York City from a plurality of sneakers.

The user then rotates the cube to a second face, as depicted in FIG. 6C, which displays the plurality of sneakers from which they select the best suited sneakers. The information made available to the user regarding the plurality of sneakers may include any relevant information they require to make an educated decision (e.g. sole, tread, material, etc.). As the user reviews the various products, they are required to learn about the sneakers and remember what they have learned. Once they have reviewed all the presented sneakers, the user then rotates the cube to a third face, as depicted in FIG. 6D, on which they can drag-and-drop the preferred pair of sneakers onto a facsimile of the user (or via some other selection process, such as entering the brand name of the sneakers into a text field, simply clicking on the sneaker, etc.).

If the user has selected an incorrect pair, they will receive a notification to continue playing. Once the user has selected the correct pair, they will receive a notification that they are correct. This will prompt them to rotate the cube to a fourth face with a video display screen, as depicted in FIG. 6E, where they can view the sneaker in action (either real life footage or computer rendered animation). This video display screen may also be utilized during the product review process in order to properly select the correct pair.

The user may also be required to utilize a map on a fifth face, as depicted in FIG. 6F, to determine where they are in the scope of the game, which criteria is to be used in determining the proper sneaker as per the topography of the geographic location.

The sixth face will feature a component which enables the user to purchase sponsored products, as depicted in FIG. 6G. This may be a link to an eCommerce store, a link to the sponsor's website, or information about the nearest physical retailer that sells the sponsor's products (e.g. an athletic chain retailer, shoe store, sponsor's own store, etc.). The physical retail location may be determined using the GPS or other geo-positioning component of the user's device.

As the user engages in the game and earns incentives (e.g. credits, discount percentages, cash prizes, etc.), they may redeem these incentives via this sixth face, either through eCommerce or via a physical retail location.

The above-described embodiment may be implemented by use of an internal mechanism within the device that identifies and reacts to the orientation of the device (e.g. an accelerometer), such that as the user rotates or otherwise moves the device, the geometric shape rotates on the display of the device.

The above-described embodiment may also be implemented by use of an interface that identifies and reacts to the user touching the display of the device (e.g. a touchscreen), such that as the user touches the display of the device, the geometric shape rotates on the display of the device. There may be other mechanisms for rotating the geometric shape of the game.

Once a game is complete, another new game may begin immediately at the prior game's conclusion, thus opening a new geometric shape.

In a method embodiment, a first step or function required to configure a geometric shape-centric game may be referred to as strategic planning. Strategic planning requires either the server to present the game template, or a live account manager to meet with a sponsor to support development of a content-delivery strategy in cooperation with the game template. In either case, based upon that sponsor's requirements (i.e. what brand to they wish to promote, who is their target audience, what type of game do they wish to make available, etc.), this first step is carried out.

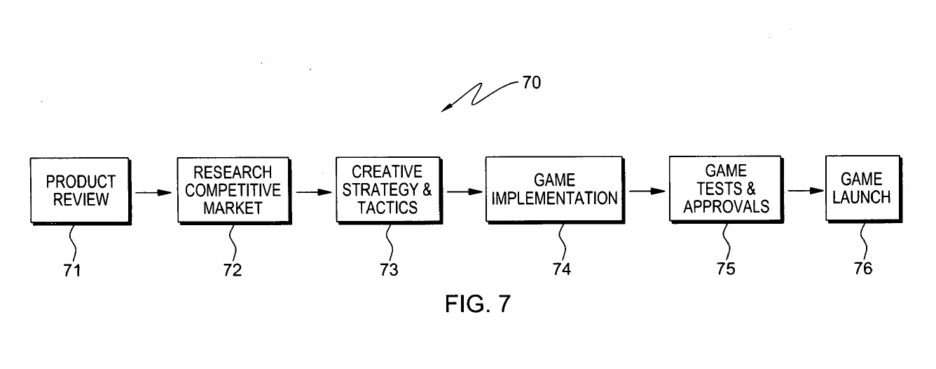

For example, the sponsor first compares their ad content to that of competitive products, as well as a comparison to lesser means (i.e. “life without the advertised product”), indicated by block 71 in FIG. 7. The next step entails researching what is currently available from similar sponsors, for example, what products they are advertising, how they are advertising said products, etc., as indicated by block 72. The researching step can further include efforts to determine how the product the sponsor seeks to promote improves the life of the user, as indicated by block 73. This might include analysis of assets, new assets and collaterals. The next step, GAME IMPLEMENTATION, indicated by block 74, entails the finalization and creation of the sponsor's fully realized interactive geometric shape-based game based upon the selected template. Once that is complete, the next step, GAME TESTS & APPROVALS, is indicated in block 75, which includes an initial test might for client through the presentation of a facsimile of the game for the sponsor's review and approval. Another part would be a beta test or a series of beta tests, implemented in order to review and revise as market conditions dictate. The last step, GAME LAUNCH, is indicated by block 76, whereby the game is uploaded to the server for distribution to the users' electronic devices. This entire process is conducted only after the sponsor has registered on the server and paid the fee required to utilize the herein defined platform. All materials on the server are maintained by the webmaster or other such individual or group of individuals assigned with managing the server's operation, in accordance with the security function.

In one embodiment, the participating consumers are enabled to receive good deals, discounts, and information from advertisers for no charge. The likelihood of users opting in to participate and receive the advertised content is higher if they do not have to pay for it. No cost to consumer means more users and greater number of eyeballs. In this embodiment, the high number of free users means the advertisers pay to play.

In another embodiment, the participating consumers pay a fee for the opportunity to receive exclusive deals, higher discount rates, and the ability to win prizes (products, vacations, cash, etc.). This may be accomplished via a nominal download fee (e.g. $2.99), through ongoing subscription fees (e.g. $2.99 per month for continued gameplay), or some combination of an initial download fee, followed by ongoing micro-transaction fees throughout the gameplay (e.g. $2.99 to download, then $0.99 to purchase elements during the gameplay, e.g. virtual equipment within the game, a clue for use in gameplay, etc.). These and like functions are all defined by the sponsor during the template configuration process.

As an incentive for purchasing and then engaging with the game, each participating consumer may receive a “minimum guarantee”—e.g. a minimum of $5 off on every purchase of a sponsored product. In this model, the ability to receive better deals and free products means the participating consumers pay to play (and subsidize the discounts provided by the marketer). Since the consumers are paying to interact with the sponsored game, they fees they pay to do so would offset the costs of the sponsor when offering reduced prices on their products.

Benefits of the invention include enabling participants, through use of the proprietary platform, multiple options to geometric shape-based games. They then enable or configure the chosen game templates with content about a combination of products the wish to merchandise. There choices should ensuring on-going player interest and participation in the games so configured. Predictably, the sponsor-configured games provide a more immersive branded entertainment experience for the participating consumer. It follows that a choice of a number of such games empowering participating consumers to make their own product decisions by selecting which sponsors' games they receive and chose to interact with. These decisions will typically be based on the sponsor's products/services, discounts, and/or cash prizes available in a game.

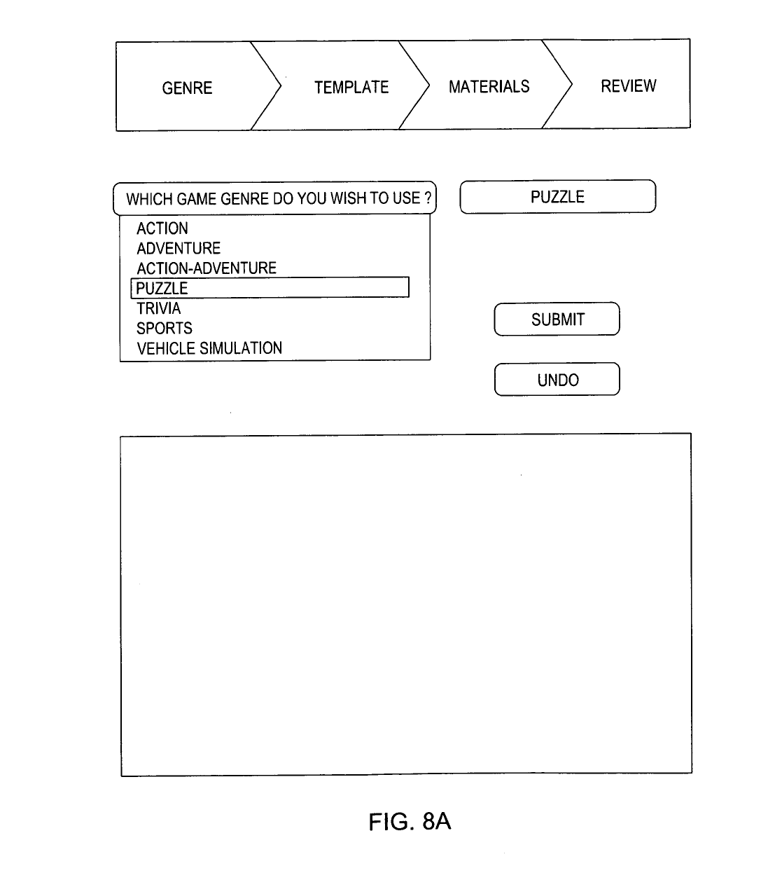

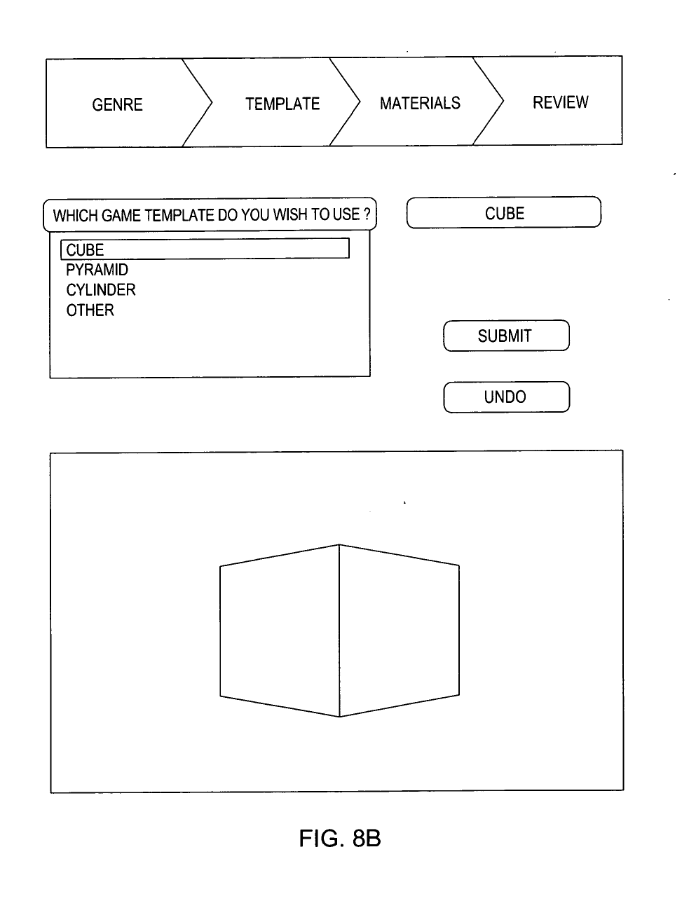

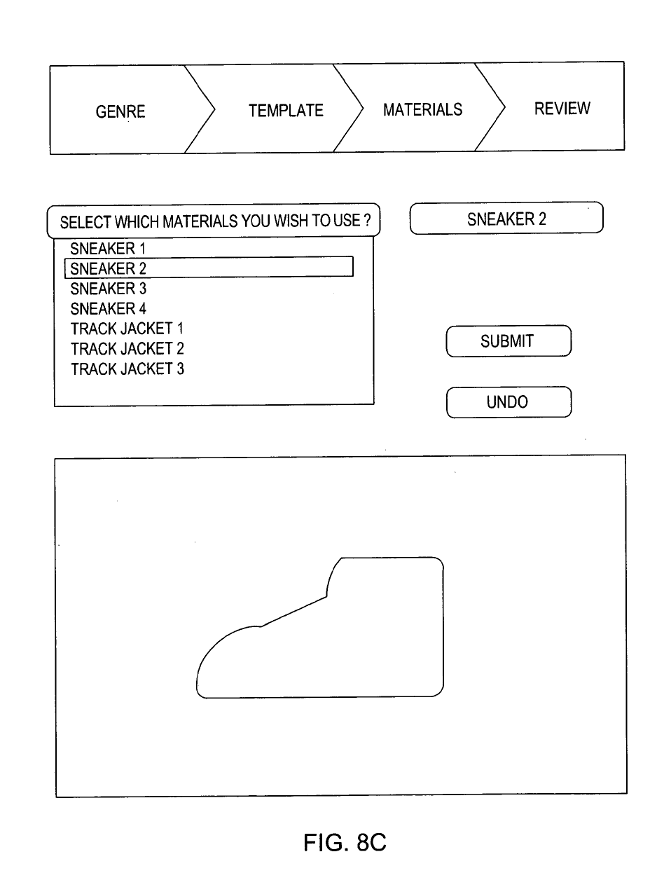

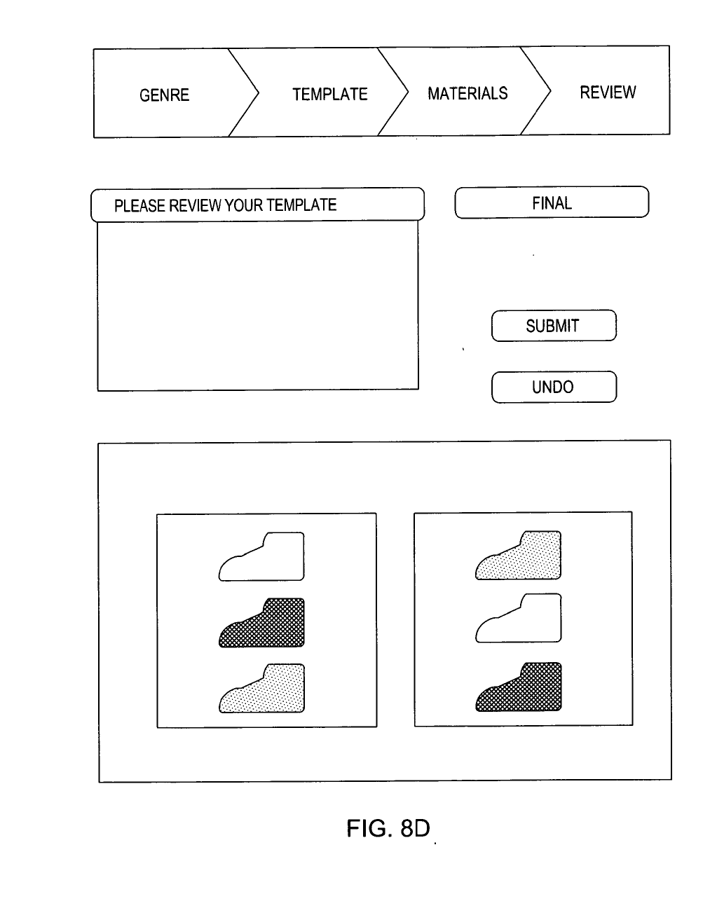

FIGS. 8A, 8B, 8C, 8D present various display screens presented to sponsors to enable the sponsor to choose a game genre, template, define game materials and perform a template review;

In FIG. 8A, the sponsor will be asked to select which genre of game they wish to utilize, including but not limited to action games, adventure games, action-adventure games, role-playing games, life simulation games, vehicle simulation games, strategy games, music games, party games, board games, puzzle games, trivia games, and sports games.

In FIG. 8B, the sponsor is then presented with a series of templates from which they can render their specific game. This may include selecting which geometric shape to utilize and how many sides will be dedicated to advertising and how many will feature the game play components. In FIG. 8C, the sponsor will be asked a plurality of questions, to include how many products they wish to promote (i.e. a single product, a line of products, or a plurality of product lines). Once the sponsor has decided which product(s) to promote, they then upload their materials (e.g. images, audio, video, etc.) to the server for application to the game template. They will also be asked to determine how many players may play the game at one time (i.e. single player, multi-player, team, etc.). A series of other questions/options will follow to help the sponsor render their game, including but not limited to: will there be a fee to download the game, will there be a fee to continue playing the game (i.e. a subscription), will there be a fee to purchase content or elements during the gameplay (i.e. micro-transactions), etc.

Once they have done this, they will be presented with a virtual facsimile of their game template, as in FIG. 8D, so they can then drag-and-drop the unique components to each face of their game template. This will be determined by what genre and type of game they selected during the initial steps. The user may upload to the server all required media and materials for applying to the template, and then select which elements to apply to which face, in accordance with the selected game template.

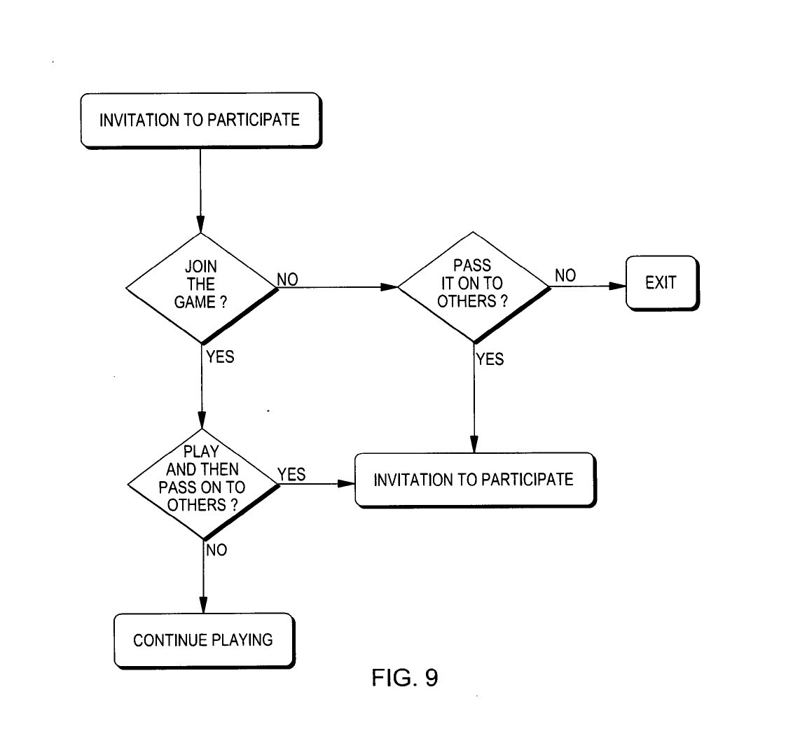

FIG. 9 depicts process flow that enables a viral marketing effect to arise from multiple player use;

In a first step, as shown in FIG. 9, a player, an other player, the computer server that manages the platform or a sponsor computer each may communicate through their respective GUIs to direct an invite “to play” or “to participate” to any number of players registered to play a particular sponsor-configured game. The first step is indicated by block 210. Upon receipt of an invite at a player's electronic device, the user responds either by joining the game or not joining the game, as indicated by decision diamond 220. If the user joins opts not to join the game, the player may them manipulate the game GUI to either pass the invite on to others, or not, as indicated by decision diamond 225. If the player opts not to pass on the invite to others, they process flow takes them out of the active gameplay, as indicated by block 230.

If the player opts to pass on the invite to another, they do by communicating the invite (passing it on) using a communication function provided for in the player GUI, as indicated by block 235. Where a player opted to join the game in response to an invite (220), the player may play the game and then pass on the invite to others, or just play the game, as indicated by decision diamond 240. If the player plays the game and then passes on the invite to others, process flow advances to block 235. The case where the player just plays without passing on the invite is indicated by block 245. Program flow passes from blocks 235 and 245 out of the active gameplay, as indicated by block 230.

The invention includes a GPS-tracking function, which relies on GPS tracking hardware in an electronic device. The sever would utilize the GPS within the device to locate specifically where the user is and deliver sponsor-specific geometric shape-based games to them based upon that location. For example, if they were near a certain restaurant, the server might send to the user's device content in the form of a geometric shape-based game based on the restaurant or traditional advertising related to that restaurant e.g. daily specials. If the user is not interacting with the server on a device with GPS enabled, they can manually enter their location via their personal profile menu.

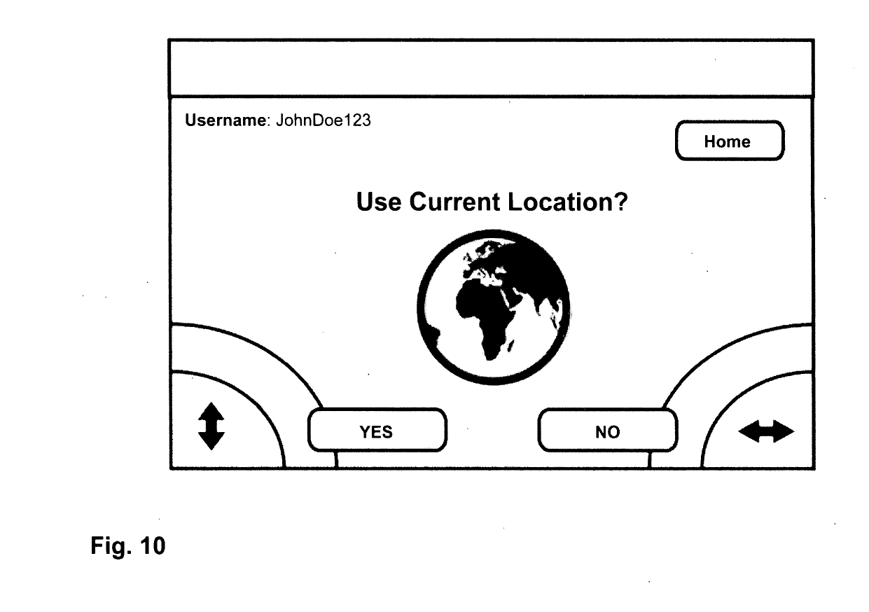

Via the internal GPS-tracking function within the user's device, the user's location will be known at all times. Where the game is operating online, this tracking information may be uploaded to the sponsor whereby the sponsor can process same and respond by sending geographic-specific content to the user based on their location. The user will have the option to opt out of said feature, as depicted in FIG. 10.

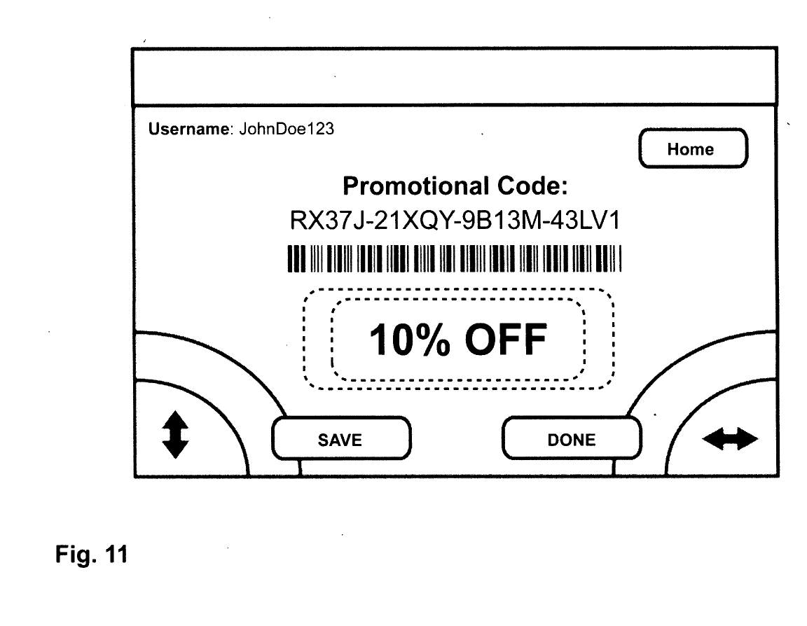

In the event the user has turned off their GPS location, the sponsors will still be able to track users by geographic location due to a unique code on each and every coupon the users receive for interaction with or completion of the game, as depicted in FIG. 11. Said codes will be unique to each and every user upon each and every experience, making each and every game interaction trackable upon redemption of the associated promotional codes.

These unique codes will be scanned or otherwise processed at the point of purchase and will enable the sponsor to identify where said code was redeemed. Via utilization of these unique coupon-based incentives, the sponsors can track at what kind of retail outlet the users are redeeming their codes (whether redemption would take place via a web-based store or a physical retail location).

Once a user has received a promotional code and is notified of the nearest retail location via their GPS or other such service, they may go to said retail location to redeem the promotional code.

Once inside a retail location, if the specific retailer includes local signal-enabled transceiver (e.g. Bluetooth), said retailer may then send to the user's handheld electronic device their own promotional material and advertising, which handheld electronic device first provides the players personal data found in the configured shell. A server unique to the retailer may download advertising content to the user's device directly, pursuant to the local signal communication.

In the foregoing description, certain terms and visual depictions are used to illustrate the preferred embodiment. However, no unnecessary limitations are to be construed by the terms used or illustrations depicted, beyond what is shown in the prior art, since the terms and illustrations are exemplary only, and are not meant to limit the scope of the present invention.

It is further known that other modifications may be made to the present invention, without departing the scope of the invention, as noted in the appended claims.

What is claimed is:

1. A system for delivering advertising content via sponsor-configured games thematically focused on a three-dimensional (3D) virtual object presented for user manipulation in a player graphical user interface (GUI) within a player electronic device during gameplay, comprising:
a computer server programmed to operate a sponsor graphical user interface (GUI) function to enable sponsor electronic devices to electronically interface with the computer server and to configure a game template with specific sponsor advertising content to create a sponsor-defined interactive game application; and
at least one player electronic device for operating the sponsor-defined interactive game application to interact with and manipulate the 3D virtual object via a game player GUI while receiving the sponsor advertising content.

2. The system of claim 1, wherein the sponsor-defined interactive game application and the player GUI are controlled by any of: the sponsor-defined game application directly, the computer server by an indirect electronic connection to the player electronic device and a sponsor computer server by an indirect electronic connection.

3. The system of claim 2, wherein the computer server or the sponsor computer server electronically connects to the at least one player electronic device to receive player information and to deliver new sponsor specific advertising content.

4. The system of claim 3, wherein the new sponsor specific advertising content is delivered during gameplay.

5. The system of claim 3, wherein the new sponsor specific advertising content is delivered in accordance with criteria from any of the group consisting of: player demographic data; player geographical data; player psychographical data; player prior use data, chronological data, seasonal data, sponsor sales data, sponsor promotional data, and player prior purchase history.

6. The system of claim 1, wherein the player electronic device is a hand-held electronic device and includes means for sensing various device movements, wherein the game player GUI detects the movements and interprets same as various player inputs for manipulating the 3D virtual object.

7. The system of claim 1, wherein 3D virtual object is a cube and wherein an unlimited number of virtual cube faces are presented through the player GUI that contain game content interspersed with sponsor-defined advertising content.

8. A processor-implemented method for delivering advertising content via sponsor-configured interactive games thematically focused on a three-dimensional (3D) virtual object, comprising acts of:
operating a computer server to enable sponsor computers to electronically connect to the computer server and configure a game template with sponsor-defined advertising content to create a sponsor-configured interactive game application;
receiving the sponsor-configured interactive game application on a player electronic device;
operating the sponsor-configured interactive game application in the player electronic device during which the player interacts with the 3D virtual object to play the sponsor-configured interactive game application while the sponsor-defined advertising content is delivered thereby.

9. The processor-implemented method for delivering advertising content as set forth in claim 8, wherein the act of operating the computer server requires that a graphical user interface (GUI) present a number of interactive display images to the sponsor computer in order to prompt the sponsor and collect data required to complete the game template.

10. The processor-implemented method for delivering advertising content as set forth in claim 8, wherein the act of operating the computer server includes communicating with the player electronic device to enable delivery thereto of sponsor-defined advertising during gameplay and during times when the interactive game application is not being played.

11. The processor-implemented method for delivering advertising content as set forth in claim 8, wherein the act of operating the computer server includes communicating with the player electronic device to enable collection of player-specific data both during gameplay and during times when the interactive game application is not being played.

12. The processor-implemented method for delivering advertising content as set forth in claim 8, wherein the act of operating the computer server further includes enabling the sponsor computer to electronically communicate with the interactive game application when it is operational on a player electronic device.

13. The processor-implemented method for delivering advertising content as set forth in claim 8, wherein the act of operating the computer server includes that the 3D virtual object is a virtual cube.

14. The processor-implemented method for delivering advertising content as set forth in claim 8, wherein the sponsor-configured interactive game application operates directly at the server, wherein the player electronic device communicates with the game application over the Internet in interactive sessions.

15. The processor-implemented method for delivering advertising content as set forth in claim 8, wherein the act of operating the sponsor-configured interactive game application presents the 3D virtual object in a player graphical user interface (GUI) which allows the player to manipulate the 3D virtual object and other game input devices.

16. The processor-implemented method for delivering advertising content as set forth in claim 15, wherein the GUI allows the player to configure a proprietary 3D virtual shell with user data, which shell takes the place of the 3D virtual object in any and all sponsor-configured interactive game applications, as well as enabling direct player intercommunication with the computer server or a sponsor computer server.

17. The processor-implemented method for delivering advertising content as set forth in claim 8, wherein the act of operating the sponsor-configured interactive game application collects user data for delivery to the server, or to a sponsor-controlled server.

18. The processor-implemented method for delivering advertising content as set forth in claim 8, wherein the act of operating the sponsor-configured interactive game application uploads collected user data to the server or to a sponsor-controlled server during active gameplay or during times when the interactive game application is not being played.

19. A processor-implemented method for delivering advertising content via a sponsor-configured interactive game thematically focused on a three-dimensional (3D) virtual cube, which is manipulated by moving a player hand-held electronic device within which the interactive game is operational, comprising acts of:
operating a computer server to enable sponsor computers to electronically connect to and configure a cube-centric game template with sponsor-defined advertising content to create a sponsor-configured interactive game application;
receiving the sponsor-configured interactive game application on the player hand-held electronic device enabled to sense and respond to user-imposed physical movements as user-defined game input;
operating the sponsor-configured interactive game application in the player hand-held electronic device during which the player grasps the hand-held electronic device with both hands to play the interactive game application through coordinated, repetitive movements by both the player's left and the right hands while the sponsor-defined advertising content is delivered, which left and right hand movements trigger a subliminal communication of said sponsor-defined advertising content to the player's subconscious brain, recallable even after active gameplay, due to the high level of repetition of the left and right hand movements.

20. The processor-implemented method as set forth in claim 19, wherein the left and right hand movements open up a portal defining a pathway the brain stem, where the advertising content is imprinted.
